(19) United States
(12) Patent Application Publication
(10) Pub. No.: US 2017/0005611 A1
(43) Pub. Date: Jan. 5, 2017

(54) ROOF TILE WITH INTEGRATED RISER

(71) Applicant: Mitch ATCHLEY, Yorba Linda, CA (US)

(72) Inventor: Mitch ATCHLEY, Yorba Linda, CA (US)

(21) Appl. No.: 15/198,373

(22) Filed: Jun. 30, 2016

Related U.S. Application Data
(60) Provisional application No. 62/188,304, filed on Jul. 2, 2015.

(51) Int. Cl. H02S 20/25; E04D 3/26; E04D 3/32; E04D 3/34; E04D 3/24; E04D 3/30

(52) U.S. Cl. CPC H02S 20/25; E04D 3/24; E04D 3/30; E04D 3/32; E04D 3/34; E04D 3/26

(57) ABSTRACT

Improvements a roof tile with an integrated riser is disclosed. The roof tile with integrated riser has the shape and color to provide a similar appearance to the original tiles. The integrated riser provides a support and complete sealing to prevent intrusion from water through the riser. The riser can be formed by insert casting the riser into the roof tile, or can be bonded into a pocket in the roof tile. The composition of the roof tiles can be adjusted to reduce how brittleness of the tile. The roof tile is secured to the roof sheeting and studs. Filler material in the tile composition can also provide additional sealing capability to nails or screws that are used to secure the roof tile. The roof tile is a simpler installation that does not require removal of a large number of tiles from the existing roof.

### CROSS REFERENCE TO RELATED APPLICATIONS

This application claims the benefit of Provisional Application Ser. No. 62/188,304 filed Jul. 2, 2016 2015 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Field of the invention

This invention relates to improvements in a roof tile with an integrated riser. More particularly, the present roof tile with an integrated riser is a replacement tile for a roofing tile that has an integrated riser to secure solar panels or other elevated structure above the roof.

Description of Related Art including information disclosed under 37 CFR 1.97 and 1.98.

When solar panels or other structure is placed above an existing roof, multiple roof tiles must be removed to secure the support structure that will hold the solar panels to the roof structure. The previous tiles must then be cut to fit around the supporting structure for the solar panels. In a typical installation, nearly all of the tiles that are installed under the solar panels must be removed to secure the support structure the corners and center of the solar panels to prevent the solar panels from being lifted or moved from rain or wind that blows onto the house or building.

A number of patents and or publications have been made to address these issues. Exemplary examples of patents and or publication that try to address this/these problem(s) are identified and discussed below.

U.S. Patent Publication Number 2013/0280448 was published on Oct. 24, 2013 to James D. Bennett discloses Solar Panel Ready Tiles. These tiles have integrated solar panels built into the tile itself. These tiles do not have a mechanism for securing a solar panel in an elevated condition above the tile.

U.S. Patent Publication Number 2008/0302408 was published on Dec. 11, 2008 to Peter Bressler et al., discloses a Method of Manufacturing an Integrated Solar Roofing Tile. This method requires removal of the existing roofing tiles and replacement of the existing roofing tiles with new rodding tiles that have integrated solar panels. The method requires securing a support structure to the roof sheeting prior to installation of the solar collecting roofing tiles.

U.S. Patent Publication Number 2006/0260670 was published on Nov. 23, 2006 to Miho Terunuma et al., discloses A Structure Fixing Apparatus Including Support Device. The support structure requires removal of existing tiles and then drilling through the removed existing tiles and then driving a structure through the drilled tile. The solar tile is then secured to the structure. While this patent provides a support structure for the solar panels above the roofing tiles. The tile itself does not support the solar panel.

U.S. Patent Publication Number 2003/0101662 was published on Jun. 5, 2003 to Stanley A. Ullman discloses a Mounting System for Supporting Objects. The mounting system is essentially risers that are mounted to the sheet structure and then the previous roofing tiles are then trimmed and placed around the risers. While this mounting system provides a structure for securing the solar panels in an elevated configuration, the structure is not made replacement roof tiles.

What is needed is a replacement roofing tile that has the same appearance as previous housing tiles, with the exception of riser integrated into the roof tile. This provides a mounting for solar panels and further keeps the roof sealed from the weather without penetrating existing roof tiles. The roof tile with an integrated riser proposed in this document provides the solution.

### BRIEF SUMMARY OF THE INVENTION

It is an object of the roof tile with an integrated riser to be a replacement for a pre-existing roof tile. The shape and color provides a similar appearance to the original tiles that were placed onto the roof. This allows the homeowner to look at the roof under the solar panel, or other item that is secured to a roof, to have a similar appearance as the previous roof tiles. The shape of the tile can be flat “S”, “W” or other shaped tile.

It is an object of the roof tile with an integrated riser. The integrated riser provides a complete sealing of the roof tile to prevent intrusion from water through the riser. The riser can be formed by insert casting the riser into the roof tile, or can be bonded into a pocket in the roof tile. The composition of the roof tiles can be adjusted to reduce how brittle the tile can be. The roof tile can further include load distributing ribs that help transfer loads from the riser to the rood sheeting and studs.

It is another object of the roof tile with an integrated riser to be sealed. The preferred embodiment of the roof tile does not have any openings that would allow water to pass through the tile. The roof tile is secured to the roof sheeting and studs with common securing techniques that would normally secure a roofing tile. Filler material in the tile composition can also provide additional sealing capability to nails or screws that are used to secure the roof tile.

It is still another object of the roof tile with an integrated riser to be a simpler installation that does not require removal of a large number of tiles from the existing roof. Without removing a quantity of roof tiles and then modifying the existing roof tiles to provide clearance and sealing of the original roof tiles. An installer would simply remove the desired tiles and place the tiles with integrated risers. The supporting frame is aligned and then the solar panels are mounted on the frame structure to support the weight of the solar panels.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows an “S” roof tile with an integrated riser.

FIG. 2 shows a top view of an “S” roof tile with an integrated riser.

FIG. 3 is a cross-section of the roof tile from FIG. 2 cut through lines 3-3.

FIG. 4 shows a rail for a solar panel array using the roof tiles with integrated risers.

FIG. 5 shows a top perspective view of a flat roof tile with an integrated riser.

FIG. 6 is the underside of the flat roof tile from FIG. 5.

FIG. 7 shows a formed metal roof tile with an integrated riser.

### DETAILED DESCRIPTION OF THE INVENTION

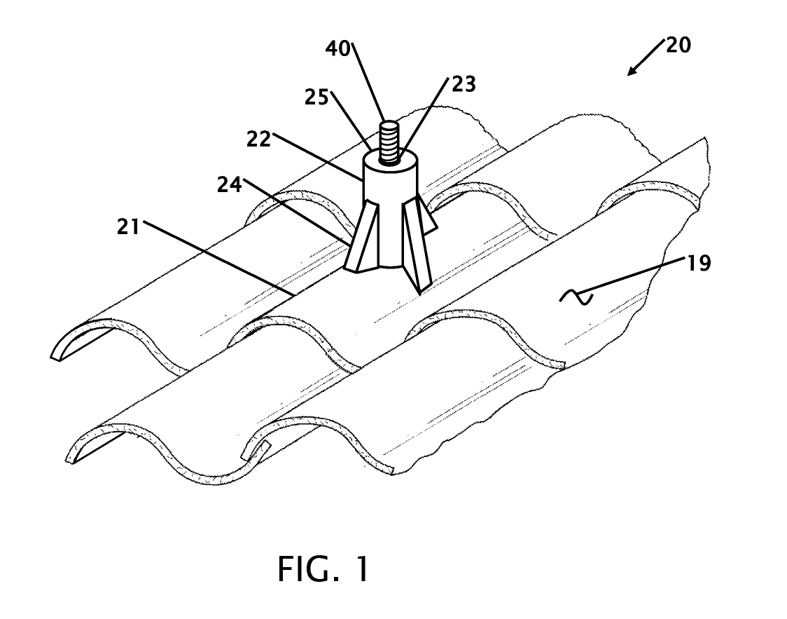

FIG. 1 shows an “S” roof tile 21 with an integrated riser 22. From the perspective of a person looking at the “S” roof tile 21, the roof tile appears like other “S” roof tiles 19 with the exception of the riser 22. The “S” roof tile 21 is installed onto the roof 20 by removing an existing roof tile and then installing the “S” roof tile 21 onto the roof sheeting with nails, screws or the like. Once one or multiple “S” roof tiles 21 are installed the railings can be installed on the riser 22. The “S” roof tile 21 has a central hole 23 for securing a fastener into the riser. The riser 22 can have a threaded stud that extend out the top 25 of the riser 22 for securing a railing system. It is contemplated that the hole 23 can be a blind hole wherein an installer can bond a stud or drill through the blind hole 23 to install or bond a fastener. It is also contemplated that the hole can include a threaded nut or other fastener.

The riser 22 has a plurality of ribs 24 that extend from the top “S” body of the tile to the side of the riser 22. In this embodiment, four ribs, but more or less than four ribs are contemplated. Other rib shapes such as fillets or radius or rounds are contemplated that provide structural strength to the riser 22 to support the railing and the solar panels that will be secured to the riser.

Most roof securing structures are made from ductile metals that can flex under temperature, weather, environmental condition and compression loads. The bonding agent can be recycled tires, epoxy or silicon. This is somewhat in contrast to standard “S” roof tiles 21 that are made from cast cement or concrete. To allow the “S” roof tile 21 with an integrated riser 22 to have longevity on a roof with the “S” roof tile 21 is formed with an embedded wire mesh and or the aggregate that the “S” roof tile 21 is made from steel or a composite of material that may include plastic, clay, sand, concrete, cement, rubbers or recycled tires. These materials make the “S” roof tile 21 less brittle and able to operate as equivalent to a metal riser. The “S” roof tile 21 provides a flexible post for securing a rail system for securing solar panels. In this figure a threaded rod 40 or similar member is shown extending through a central hole 23 from the top of the riser 22. Rails can be secured to the rod 40 and solar panels can then be secured to the rod 40

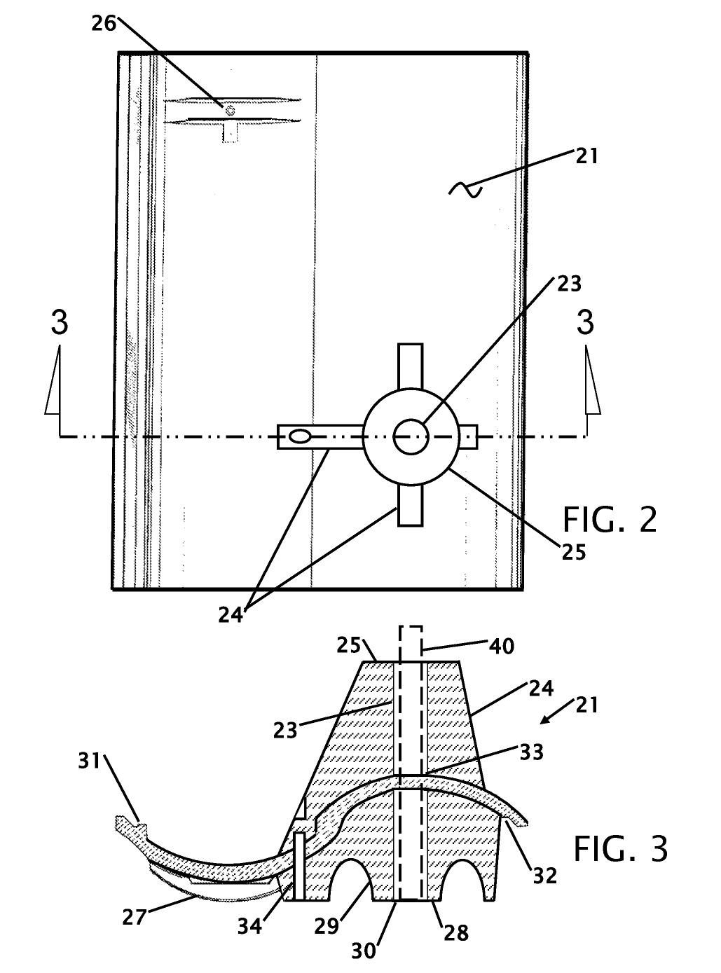

FIG. 2 shows a top view of an “S” roof tile 21 with an integrated riser, and FIG. 3 is a cross-section of the roof tile from FIG. 2 cut through lines 3-3. The top view shows the riser and ribs 24 that support the riser. The central hole 23 in this embodiment has an open bottom hole 30 with a skin 33 between the upper hole 23 and the lower hole 33. This would allow a stud to be bonded into the upper hole 23. The tile 21 can be formed without the skin 33 and a stud 40 integrated into the tile 21, because the hole is filled with an insert material can't pass through the hole when the solar panel and railing system is secured to top surface 25, of the roof tile 21. The top surface of the tile 21 is cosmetic, while the underside includes one or more structural ribs 27 or details.

The underside of the S roof tile also has a plurality of ribs 28 that displace loads on the riser. The loads on the riser 25 are distributed down the riser through the upper wall of the tile and into the rib structure under the “S” wall. The distribution of the loads from the riser to the roof sheeting prevents damages of loads on the riser from fracturing the area where the riser joins the top surface of the tile 21. The ribs 28 on the underside also have clearance areas 29 that both allow for drainage and lighten the tile 21. Ribs 28 and 27 lift the surface of the tile above the roof to allow for some natural air circulation. The edges of the tile have surfaces 31 and 32 that allow for interconnection of adjacent tiles to nest. One or a plurality of holes 26 allow for securing the tile 21 to the roof sheeting, rafters or studs. It is further contemplated that additional blind holes 34, passageways or indentations can be located in the ribs to further secure the tile. These holes 34 or recesses are “blind” until they are penetrated. The holes are blind to prevent water penetration, but provide a starting location for drilling and/or insertion of a fastener. These features can be caulked to seal the openings.

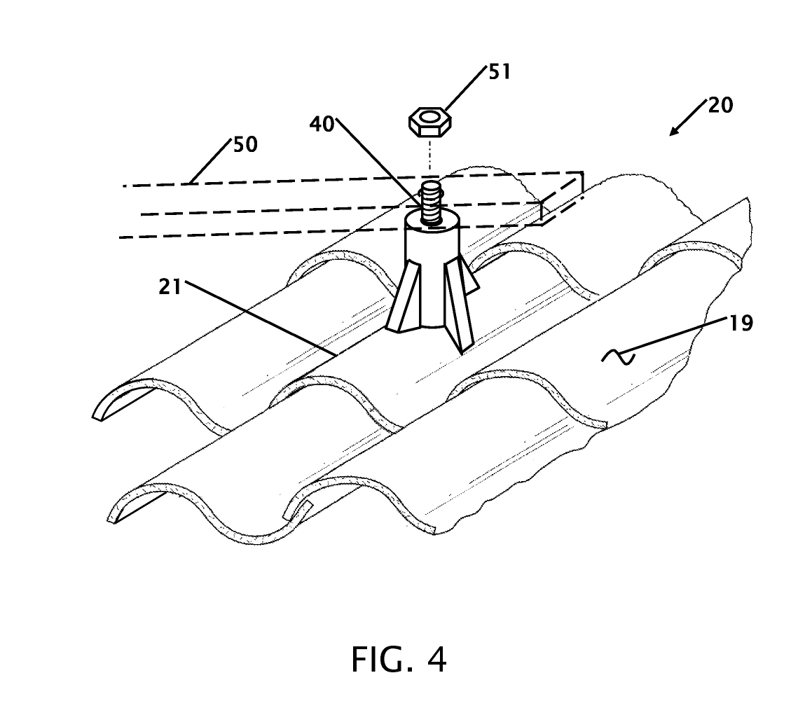

FIG. 4 shows a rail for a solar panel array using the roof tiles 19 and roof tiles 21 with integrated risers. This figure is the typical view of a roof 20 that would include multiple risers that have the supporting rails 50 secured to the top risers on studs 40 that would be secured with a nut 51 or other hardware. Additional structure is secured to the rails 50 and the solar panels are then secured to the railing system. The solar panels are then electrically connected from the solar panels to inverters and then to the house wiring or batteries. The roofing tiles 19 and 21 are secured to the roof sheeting and rafters and supply sufficient structural strength to keep the solar panels secured through weather conditions.

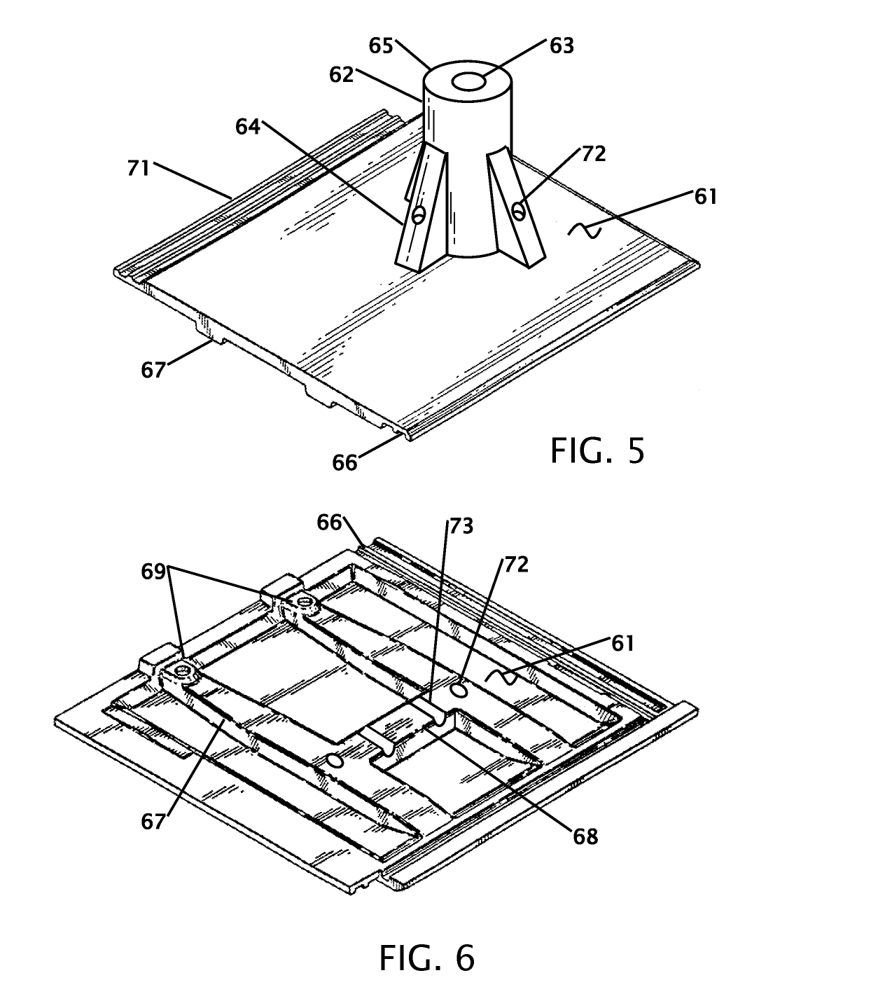

There are essentially three basic types of popular roofing tiles. The most common types are the previously disclosed “S” tiles the flat version shown in FIG. 5 as a perspective view of a flat roof tile with an integrated riser and “W” style roofing tiles.

FIG. 5 shows a top perspective view of a flat roof tile with an integrated riser and FIG. 6 is the underside of the flat roof tile from FIG. 5. This roof tile is essentially flat or parallel between the top and bottom surface, on the riser has supporting ribs 64 that extend from the riser to the top surface of the roof tile. The underside of this tile has a number of parallel ribs 67 that support the tile on a roof and also reduce the amount of material that is being used and the therefore also reduces the weight of each flat roof tile.

The riser 62 has a plurality of ribs 64 that extend from the top of the tile 61 to the side of the riser 62. In this embodiment, four ribs, but more or less than four ribs are contemplated. Other rib shapes such as fillets or radius or rounds are contemplated that provide structural strength to the riser 62 to support the railing and the solar panels that will be secured to the riser. The top surface of the tile 61 is cosmetic, while the underside includes one or more structural ribs 67 or details.

Most roof securing structures are made from ductile metals that can flex under temperature, weather, environmental condition and compression loads. This is somewhat in contrast to standard flat roof tile that are made from cast cement or concrete. The tile body may be made up of any of the commercially available materials (such as clay, plastic or glass) and may be with industry standard specifications. It is also contemplated that the tile can be formed from steel or aluminum metal. In other words, each of the dimensional specifications (such as length, width, height and curvatures, externally and internal) of the tile body may be set as an industry standard and is manufactured according to these standard dimensions. Some of the tile bodies that fit into the edges of the roof or on the top most edge of the roof may have slightly different designs from the one illustrated.

To allow roof tile 61 with an integrated riser 62 to have longevity on a roof, the roof tile 61 can be formed with an embedded wire mesh and or the aggregate that roof tile 61 is made from a composite of material that may include clay, sand, plastic, rubbers or recycled tires. These materials make the roof tile 61 less brittle. The tile can also be formed from sheet metal or cast. The roof tile 61 provides a flexible post for securing a rail system for securing solar panels. A threaded rod or other securing member can be bonded or integrated into the central hole 63. The hole can extend partially or completely through the roof tile 61. Rails can be secured to the threaded rod or other securing member and solar panels can then be secured onto the top surface 65 of the riser 62.

The edges or side areas 66, 71 of the tile 61 allow for joining or interconnection with other tiles. A supporting rib 68 is located under the riser to support weight placed on the riser 62. It is contemplated that one or more slots can be placed in this rib to promote air circulation and or drainage under the tile. Hole 69 allow for the tile 61 to be secured to the roof sheeting, rafters or studs. It is further contemplated that additional holes 72, passageways or indentations 73 can be located in the ribs to further secure the tile. These holes 72 or recesses are “blind” until they are penetrated. The holes are blind to prevent water penetration, but provide a starting location for drilling and/or insertion of a fastener. These features can be caulked to seal the openings.

The tile roof institute has installation of theses such roofing products to have base flashing in to tar paper to ensure the penetration is water proof under the tile. The roofing tile with integrated riser has an outer seal and an inner seal that compresses when the roofing tile is secured to the roof deck to seal the roof tile with integrated riser to pre-existing tar paper thereby eliminating the need to sub-flash the roofing and to make the tile a replacement tile with a built-in riser mount.

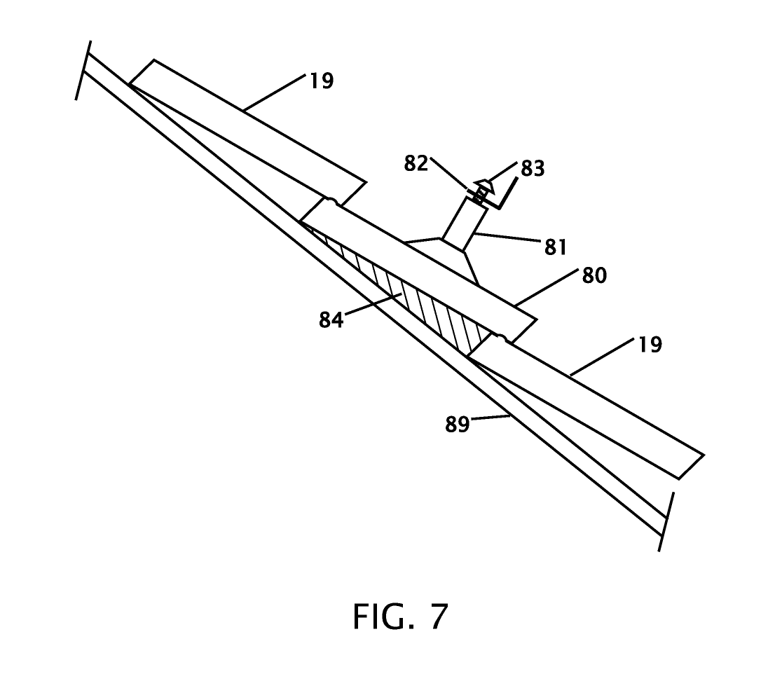

FIG. 7 shows a formed metal roof tile with an integrated riser. This embodiment uses metal formed tile 80 where the formed tile is made from steel or aluminum. The forming of the tile allows the tile to be nested with adjacent existing roof tiles 19. The formed tile 80 has an integrated solid base 84 that fills the void under the formed tile 80. The riser area 81 elevates the stud above the tile face. The riser 81 is shown with an angle bracket 82 that is secured with a fastener 83. Alternative brackets 82 can be used depending upon the needs of the installation. The formed tile 80 is mounted to roof sheeting 89 in a manner that is consistent with roof tile mounting.

Thus, specific embodiments of a roof tile with an integrated riser have been disclosed. It should be apparent, however, to those skilled in the art that many more modifications besides those described are possible without departing from the inventive concepts herein. The inventive subject matter, therefore, is not to be restricted except in the spirit of the appended claims.

1. A roof tile with an integrated riser comprising:
a flat or an “S” shaped roof tile having to top cosmetic surface and a bottom structural surface;
said roof tile having securing means to a roof sheeting or a stud, and
said roof tile further includes a riser elevated from said cosmetic surface of said roof tile.

2. The roof tile with an integrated riser according to claim 1 wherein said roof tile further includes a bonding agent thereby making said roof tile ductile.

3. The roof tile with an integrated riser according to claim 1 wherein said bonding agent is recycled tires, epoxy or silicon.

4. The roof tile with an integrated riser according to claim 1 wherein said riser on said roof tile has an elevated surface of between 2 inches and 12 inches.

5. The roof tile with an integrated riser according to claim 1 wherein said riser is an insert that is bonded into said roof tile.

6. The roof tile with an integrated riser according to claim 4 further includes an insert bonded to said elevated surface.

7. The roof tile with an integrated riser according to claim 4 wherein said elevated surface includes a threaded insert.

8. The roof tile with an integrated riser according to claim 7 wherein said threaded insert is a tapped hole.

9. The roof tile with an integrated riser according to claim 7 wherein said threaded insert is a threaded shaft.

10. The roof tile with an integrated riser according to claim 1 further includes at least one blind hole.

11. The roof tile with an integrated riser according to claim 1 further includes at least one rib extending from said roof tile to said riser.

12. The roof tile with an integrated riser according to claim 1 further includes at least one supporting rib on said structural surface in proximity to said riser.

13. The roof tile with an integrated riser according to claim 12 further includes at least one blind hole in said at least one rib.

14. The roof tile with an integrated riser according to claim 12 wherein said supporting rub includes a clearance area.

15. The roof tile with an integrated riser according to claim 12 wherein a bottom of said at least one rib is parallel with a bottom of said bottom structural surface.

16. The roof tile with an integrated riser according to claim 1 wherein said riser has a central hole.

17. The roof tile with an integrated riser according to claim 1 wherein said roof tile is made from a group of materials consisting of at least one of steel, aluminum, cement, sand, clay, concrete, stone, plastic, rubbers and recycled tires.

18. The roof tile with an integrated riser according to claim 17 wherein said roof tile is cast or formed.

19. The roof tile with an integrated riser according to claim 1 wherein said riser has a top surface that is parallel to said top cosmetic surface.

20. The roof tile with an integrated riser according to claim 1 wherein opposing edges of said tile have interconnecting surfaces whereby allowing adjacent tiles to nest.
